(19) United States
(12) Patent Application Publication
(10) Pub. No.: US 2004/0117359 A1
(43) Pub. Date: Jun. 17, 2004

(54) Adaptable query optimization and evaluation in temporal middleware

(76) Inventors: Richard Thomas Snodgrass, Tucson, AZ (US); Christian Sondergaard Jensen, Gistrup (DK); Giedrius Slivinskas, Vilnius (LT); Kristian Torp, Gistrup (DK)

Correspondence Address: HARNESS, DICKEY & PIERCE, P.L.C., P.O. BOX 8910, RESTON, VA, 20195, US

(21) Appl. No.: 10/469,302

(22) PCT Filed: Mar. 1, 2002
(86) PCT No.: PCT/DK02/00136

(30) Foreign Application Priority Data
Mar. 1, 2001 (DK) PA200100335

(51) Int. Cl. G06F 17/30

(52) U.S. Cl. 707/3

(57) ABSTRACT

Time-referenced data are pervasive in most real-world databases. Recent advances in temporal query languages show that such database applications may benefit substantially from built-in temporal support in the DBMS. To achieve this, temporal query optimization and evaluation mechanisms must be provided, either within the DBMS proper or as a source level translation from temporal queries to conventional SQL. This invention proposes a new approach: using a middleware component on top of a conventional DBMS. This component accepts temporal SQL statements and produces a corresponding query plan consisting of algebraic as well as regular SQL parts. The algebraic parts are processed by the middleware, while the SQL parts are processed by the DBMS. The middleware uses performance feedback from the DBMS to adapt its partitioning of subsequent queries into middleware and DBMS parts. The invention comprises the architecture and implementation of the temporal middleware component, termed TANGO, which is based on the Volcano extensible query optimizer and the XXL query processing library. Experiments with the system demonstrate the utility of the middleware's internal processing capability and its cost-based mechanism for apportioning the processing between the middleware and the underlying DBMS.

### FIELD OF THE INVENTION

Most real-world database applications rely on time-referenced data. For example, time-referenced data is used in financial, medical, and travel applications. Being time-variant is even one of Inmon's defining properties of a data warehouse. Recent advances in temporal query languages show that such applications may benefit substantially from running on a DBMS with built-in temporal support. The potential benefits are several: application code is simplified and more easily maintainable, thereby increasing programmer productivity, and more data processing can be moved from applications to the DBMS, potentially leading to better performance.

In contrast, the built-in temporal support offered by current database products is limited to predefined time-related data types, e.g., the Informix TimeSeries Datablade and the Oracle8 TimeSeries cartridge, and extensibility facilities that enable the user to define new, e.g., temporal, data types. However, temporal support is needed that goes beyond data types. The temporal support should encapsulate temporal operations in query optimization and processing, as well as extend the query language itself.

### BACKGROUND OF THE INVENTION

U.S. Pat. No. 5,544,355 describes a database application invoking foreign functions, and where the data are managed based on rules related to such foreign functions. Based on the foreign functions rewrite rules are established, and based on the rewrite rules alternative queries are generated, different from those queries that would have been proposed by the foreign functions themselves. The cost-optimisation is based selecting among a number of alternative quries based on a condition that a left-side of at least one of the rewrite rules is equivalent to at least a portion of of the input query. Only the database itself is used for conducting the alternative queries.

U.S. Pat. No. 5,864,840 describes a relational database management system including a query processor. The method according to this invention is in many way similar to the one described above, also indicated by the above-mentioned U.S. Pat. No. 5,544,355 cited. The optimisation consists of evaluating alternative query plans in order to decide where to send one table to another for so-called subqueries. One or more columns of the one table in the query are compered to one or more columns of the other tables in the subqueries. A rewritten query is then generated in order to be able to compare the tables by another query, and an alternative query plan is selected based on a least-cost optimisation. Also in this prior art document, all queries take place in the database itself.

Developing a DBMS with built-in temporal support from scratch is a daunting task that may, at best, only be feasible by DBMS vendors that already have a code base to modify and have large resources available. This has led to the consideration of a layered, or stratum, approach where a layer that implements temporal support is interposed between the user applications and a conventional DBMS. The stratum maps temporal SQL statements to regular SQL statements and passes them to the DBMS, which remains unaltered.

A stratum approach presents difficulties of its own. First, every temporal query must be expressible in the conventional SQL supported by the underlying DBMS, which constrains the temporal constructs that can be supported. Even more problematic is that some temporal constructs, such as temporal aggregation, are quite inefficient when evaluated using SQL, but can be evaluated efficiently with application code that uses a cursor to access the underlying data.

### SUMMARY OF THE INVENTION

It is the object of the present invention to even further optimise the generation and selection of query plans in order to even further optimise the cost-efficiency.

This object is obtained by the present invention proposing a generalization of the stratum approach, moving some of the query evaluation into the stratum. We term this the “temporal middleware” approach. The present invention proposes a new approach, that of temporal middleware, to evaluating temporal queries that enables significant performance benefits.

All previous approaches have consisted entirely of a temporal-SQL-to-SQL translation, effectively a smart macro processor, with all of the work done in the DBMS, and little flexibility in the SQL that is generated. Our middleware approach, in addition to mapping temporal SQL to conventional SQL, performs query optimization and some processing. Moving some of the query processing to the middleware improves query performance because complex operations such as temporal aggregation or temporal duplicate elimination have efficient algorithms in the middleware, but are difficult to process efficiently in conventional DBMSs.

Allowing some of the query processing to occur in the middleware raises the issue of deciding which portion(s) of a query to execute in the underlying DBMS, and which to execute in the middleware itself. Two transfer operations, T^{M} and T^{D}, are used to move a relation from the DBMS to the middleware and vice versa. A query plan consists of those portion(s) to be evaluated in the middleware and SQL code for the portion(s) of the query to be processed by the DBMS.

To flexibly divide the processing between the middleware and the DBMS, the middleware includes a query optimizer. Heuristics are used to reduce the search space, e.g., one heuristic is that the optimizer should consider evaluating in the middleware only those operations that may be processed more efficiently there. Costing is used to determine where to process certain operations, which is not always obvious. For example, whether to process a temporal join in the middleware or in the DBMS depends on the statistics of the argument relations, which are fed into the cost formulas.

The present invention makes several contributions. It validates the proposed temporal middleware architecture with an implementation that extends the Volcano query optimizer and the XXL query processing system. The middleware query optimization and processing mechanisms explicitly address duplicates and order in a consistent manner. We provide heuristics, cost formulas, and selectivity estimation methods for temporal operators (using available DBMS statistics); and to divide the processing between the middleware and the DBMS, we use the above-mentioned transfer operators. Performance experiments with the system demonstrate that adding query processing capabilities to the middleware significantly improves the overall query performance. In addition, we show that the cost-based optimization is effective in dividing the processing between the middleware and the DBMS. Thereby, the proposed middleware system captures the functionality of previously proposed stratum approaches and is more flexible.

The presented temporal operators, their algorithms, cost formulas, transformation rules, and statistics-derivation techniques may also be used when implementing a stand-alone temporal DBMS. This makes the presented implementation applicable to both the integrated and the layered architecture of a temporal DBMS, in turn making it relevant for DBMS vendors planning to incorporate temporal features into their products, as well as to third-party developers that want to implement temporal support.

Section 2 presents the architecture of the temporal middleware, and shows how queries flow through the system. The following section presents temporal operators, their implementations in the middleware and the DBMS, and the corresponding cost formulas. For each temporal operation, we propose a method for estimating its selectivity using standard DBMS-maintainable statistics on base relations and attributes. This is needed because standard selectivity estimation does not work well for temporal operations, as we show. Section 4 explains the transformation rules and heuristics used by the middleware optimizer. Performance experiments demonstrate the utility of the shared query processing, as well as of the cost-based optimization.

The invention relates to a database-based application comprising means for processing temporal queries from a user capable of entering queries, said application comprising the following layers: a user application layer for interaction between the user and said database-based application for entering queries, a middleware layer overlying a Database Management System (DBMS) and said middleware layer being intended for processing temporal queries from the user, a Database Management System (DBMS) layer for processing queries and for accessing data in a database, said database-based application further comprising:

means for generating a number of query plans according to queries having been entered by the user by means of said user application layer, each said query plan specifying combinations of operations to be performed and establishing whether the operation should be performed in the middleware layer or the DBMS layer, means for estimating the cost in processing resources according to each said query plan, means for selecting, according to a criteria, which query plan to be used when processing a query, said criteria being based on the result from said cost calculating means.

Thereby, more cost effective query plans can be chosen, avoiding that query plans demanding large resources compared to other plans are chosen. The resources could comprise the IO resources and CPU resources.

In a specific embodiment, the means for estimating the cost comprises means for estimating the selectivity of a temporal selection, said estimate of the selectivity being intended for using the information that an end time of a period never precedes a start time of the period. Thereby, a more exact estimation is obtained.

An advantageous embodiment of estimating the selectivity of a temporal selection can be obtained using information about temporal data to be selected from a set of data, said information being placed in histograms based on the start time and end time of the period. Thereby, an even more exact estimation can be obtained.

The invention further comprises a database-based application comprising means for processing temporal queries from a user entering a number of queries, said application comprising the following layers: a user application layer for interaction between the user and said database-based application for entering queries, a Database Management System (DBMS) layer for processing queries and for accessing data in a database, said database-based application further comprising: means for generating a number of query plans according to queries having been entered by the user by means of said user application layer, each said query plan capable of specifying combinations of operations to be performed, means for estimating the cost in processing resources according to each said query plan by estimating the selectivity of a temporal selection, said estimate of the selectivity intended for being performed by using the information that an end time of a period never precedes a start time of the period.

Thereby, a faster estimation can be obtained, further a more exact estimation is obtained.

The invention further comprises a database-based application comprising means for processing temporal queries from a user capable of entering queries, said application comprising the following layers: a user application layer for interaction between the user and said database based application for entering queries by the user, a Database Management System (DBMS) layer for processing queries and accessing the data in a database, said database-based application further comprising means for performing temporal aggregation, said means intended for performing temporal aggregation and comprising: means for sorting grouping attributes and corresponding start time of a period in a first table, and means for sorting the grouping attributes and corresponding end time of the period in a second table, and means for performing the temporal aggregation by using said first and second table.

Thereby, it might only be necessary to process each attribute once, resulting in more resources being liberated to process other operations.

### DETAILED DESCRIPTION OF THE INVENTION

2. Temporal middleware

We first present the architecture of the temporal middleware, termed TANGO (Temporal Adaptive Next-Generation query Optimizer and processor). Then follows an example of how a query is processed.

2.1 System Architecture

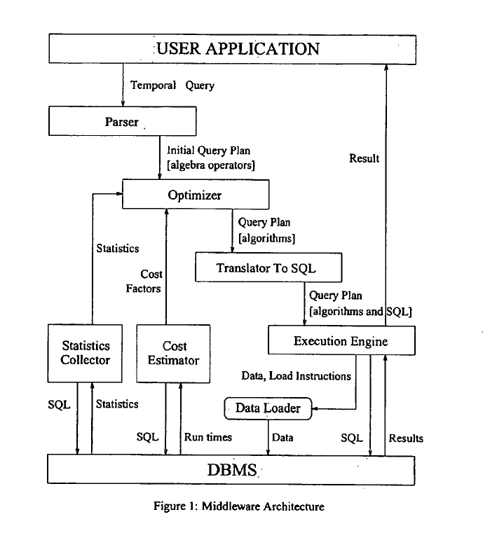

FIG. 1 shows TANGO's architecture. The parser translates a temporal-SQL query to an algebra expression, the initial query plan, which is passed on to the optimizer. This plan assigns all processing to the DBMS and specifies that the result is to be transferred to the middleware, by placing a T^{M} operation at the end.

Optimization occurs in two phases. Initially, a set of candidate algebraic query plans is produced by means of the optimizer's transformation rules and heuristics. Next, the optimizer considers in more detail each of these plans. For each algebraic operation in a plan, it assumes that each of the algorithms available for computing that operation is being used, and it estimates the consequent cost of computing the query. This way, one best physical query execution plan, where all operations are specified by algorithms, is found for each original candidate plan. To enable this procedure, the Statistics Collector component obtains statistics on base relations and attributes from the DBMS catalog and provides them to the optimizer. The Cost Estimator component determines cost factors for the cost formulas used by the optimizer. Of the plans generated, the one with the best estimated performance is chosen for execution.

The Translator-To-SQL component translates those parts of the chosen plan that occur in the DBMS into SQL (i.e., parts below T^{M}s that either reach the leaf level or T^{D}s), and passes the execution-ready plan to the Execution Engine, which executes the plan. The T^{M} operator results in an SQL SELECT statement being issued, while the T^{D} operator results in an SQL CREATE TABLE statement being issued, followed by the invocation of a DBMS-specific data loader.

Although both heuristic- and cost-based, this optimizer is lighter weight than a full-blown DBMS optimizer, because less information is available to it. While the middleware treats the underlying DBMS as a (quite full featured!) file system, it is not possible for the middleware to accurately estimate the time for the DBMS to deliver a block of tuples from a perhaps involved SQL statement associated with a cursor. This contrasts with a DBMS, which can estimate the time to read a block from disk quite accurately. However, the job of a middleware optimizer is also simpler, in that it does not need to choose among a variety of query plans for the portion of the query to be evaluated by the DBMS. Rather, it just needs to determine where the processing of each part of the query should reside. It does so by appropriately inserting transfer operations into query plans.

The optimizer component is an extended version of McKenna and Graefe's Volcano optimizer, implemented in C/C++. This optimizer has been enhanced to systematically capture duplicates and order, as well as to support several different kinds of equivalences among relational expressions (e.g., equivalences that consider relations as multisets or lists). The Execution Engine module is implemented in Java, uses the XXL library of query processing algorithms developed by van den Bercken et al., and accesses the DBMS using a JDBC interface.

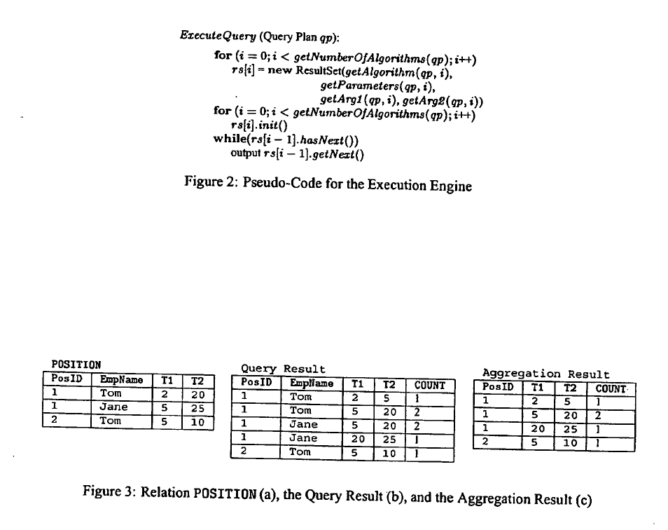

FIG. 2 describes the main function of the Execution Engine, which receives an execution-ready plan consisting of a sequence of algorithms with their parameters and arguments. For example, an algorithm implementing temporal aggregation takes grouping attributes and aggregate functions as parameters, and a relation as its argument, while an algorithm implementing T^{M} takes an SQL query as its parameter.

The function first creates result sets for all algorithms in the query plan. Each result set implements iterator interface with init() and getNext() methods, enabling a pipelined query execution. For each result set, its init() method is then invoked. Usually this method just initializes inner structures used by the algorithms, but it does in some cases more: for example, in the case of the algorithm implementing T^{D}, it fetches all tuples of the argument result set (via its getNext() method) and copies them into the DBMS.

Finally, the getNext() method of the result set for the last algorithm is invoked; in order to collect the result, it invokes the getNext()'s of the result sets for the algorithms before it.

2.2 Query Processing Example

An example illustrates how queries are processed. Consider the POSITION relation in FIG. 3(a), which stores information about the positions of employees. We assume a closed-open representation for time periods and let the time values denote days. For example, Tom occupied position 1 from day 2 through day 19, as indicated by time attributes T1 and T2. We compute the time-variant relation that, for each position tuple, provides the number of employees assigned to that position over time, sorted on the position. This relation is given in FIG. 3(b). For example, when Tom occupied position 1 from time 2 to 5, he was the only employee with that position (the count is 1), but from time 5 to 20, Jane also had that position (the count is 2).

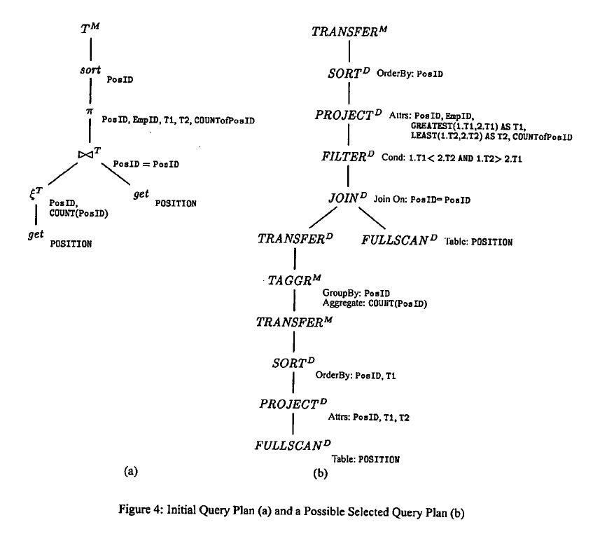

FIG. 4(a) depicts the initial query plan that the optimizer receives as input. This plan consists solely of algebraic operations and assigns all the processing to the DBMS; and a T^{M} operation is performed at the end, to deliver the resulting tuples to the middleware, which delivers them to the client. To obtain the desired result, temporal aggregation should be performed first to count the number of employees for each position over time (see its result in FIG. 3(c)). This result is then temporally joined with the POSITION relation on PosID (this join also requires time periods to overlap). The sort, operation ensures the desired sorting. Algebraic operators in the initial plan include both regular and temporal operators; temporal operators have their own algorithms for the middleware and are translated into regular SQL if they have to be evaluated in the DBMS.

FIG. 4(b) shows one of the possible query plans that can be produced by the optimizer. Operations are replaced by actual algorithms for which the optimizer has cost formulas. Superscripts for algorithm names indicate if they have to be evaluated in the DBMS or in the middleware. The given plan states that the POSITION relation first should be scanned, with relevant attributes being selected. Then temporal aggregation should be performed in the middleware. Since the temporal aggregation algorithm for the middleware, TAGGR^{M}, requires a sorted argument (see Section 3.5), a SORT^{D} algorithm is performed before transferring the argument to the middleware. The result of the temporal aggregation is transferred back into the DBMS, which then performs the temporal join (regular join followed by selection and projection). Since the middleware does not know which join algorithm the DBMS will use in each given case, the middleware optimizer uses “generic” cost formula for the DBMS join algorithm (see Section 3.1).

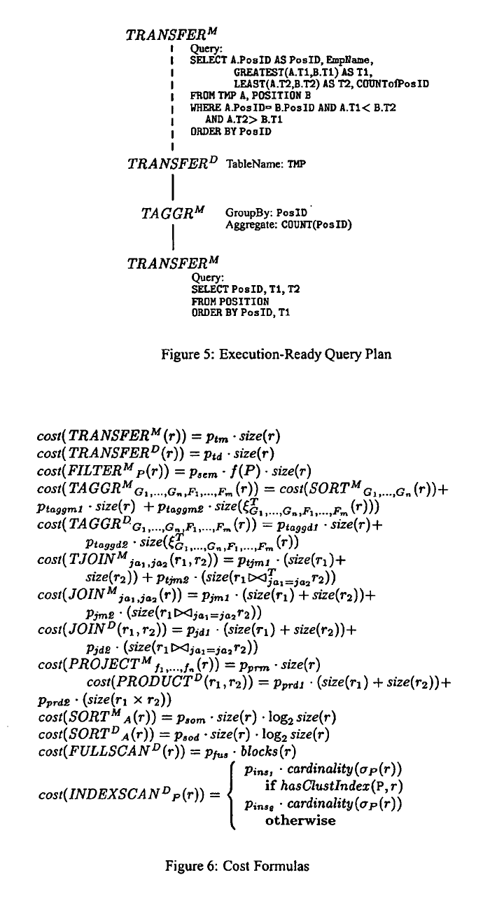

The execution-ready query plan that is passed to the Execution Engine is given in FIG. 5. It consists of four algorithms. First, TRANSFER^{M} issues a SELECT statement to the DBMS in order to obtain the argument for the temporal aggregation. Then, TAGGR^{M} performs a temporal aggregation, and its result is loaded into the DBMS by TRANSFER^{D}. Finally, TRANSFER^{M} issues a SELECT statement to the DBMS to obtain the result. In the figure, solid lines represent algorithm arguments, and dashed lines represent algorithm sequence (in this case, the top TRANSFER^{M} does not take any arguments, but must be preceded by the TRANSFER^{D} algorithm).

3 Statistics and Cost Formulas

The availability of statistics on base relations as well as the ability to derive statistics for intermediate relations are important to the query optimizer. The middleware has a separate component that collects statistics from the DBMS, either by querying base relations or by querying the statistics relations that exist in different formats in the various DBMSs. Our middleware uses standard statistics: block counts, numbers of tuples, and average tuple sizes for relations; minimum values, maximum values, numbers of distinct values, histograms, and index availability for attributes; and clusterings for indexes. These statistics and their notation are given in Table 1.

TABLE 1
Statistics and their Notation

| Notation | Description |
|---|---|
| blocks(r) | Number of blocks occupied by relation r |
| cardinality(r) | Number of tuples in relation r |
| tupleSize(r) | Average length of one topic of relation r |
| min Val(A, r) | Minimum value of attribute A in relation r |
| maxVal(A, r) | Maximum value of attribute A in relation r |
| distinct(A, r) | Number of distinct values in attribute A in |
| | relation r |
| hasHistogram(A, r) | True if there is a histogram on A in relation r |
| hasIndex(A, r) | True if there is an index on A in relation r |
| hasClustIndex(P, r) | True if there is a clustered index on attribute |
| | in selection condition P in relation r |

We will shortly describe several algebraic operators and their implementation. For each operator, we will discuss how to derive the cardinality of its result, given the statistics for its argument(s). (The statistics not described here are, in most cases, straightforward to maintain.) The main focus is to provide reasonable estimates for the temporal operations, which offers new challenges. For example, standard selectivity estimation does not estimate well the result cardinalities of selections having temporal predicates. Hence, Section 3.3 describes how to obtain more accurate selectivity estimates.

3.1 Cost Formulas

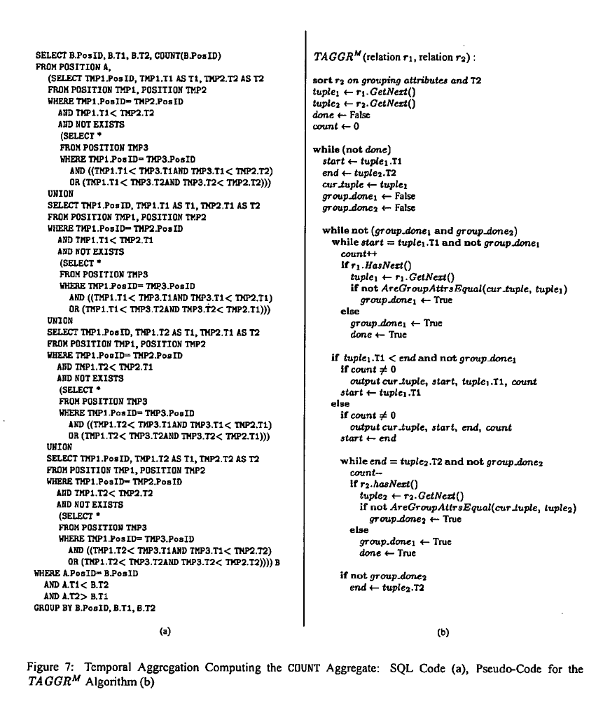

FIG. 6 gives cost formulas for the algorithms implemented in TANGO and for the operators supported by the DBMS. Additional algorithms may later be added to TANGO, including duplicate elimination, difference, and coalescing. The cost formulas incorporate I/O and CPU costs, and the unit of measure of their return values is microsecond. These formulas will be explained when each operator is discussed.

Simplified cost formulas are used, because we generally do not know which algorithms the DBMS might use for queries (hence, we consider only one DBMS implementation of temporal aggregation, even though it may be executed in many different ways).

Conceptually, the cost of an algorithm consists of an initialization cost, the cost of processing the argument tuples, and the cost of forming the output tuples. The initialization costs of all algorithms are set to zero, as are the costs of forming the outputs for sorting, selection, and projection. In addition, we assume a zero cost for selection and projection in the DBMS. Each formula has a number of cost factors p that are used to weigh the statistics, such as blocks(r) and size(r) (=cardinality(r)·tupleSize(r)); the determination of cost factors is discussed in more detail in Section 5.2. The selection cost formula includes a function that returns a coefficient representing the selection condition.

We now turn to several specific operators and their implementations, along with the cost formulas and related statistics. There is not sufficient space to discuss all operators in detail, so we focus on the most interesting ones.

For each operation, we only discuss the cardinality of the result and (where appropriate) the minimum and maximum values, the number of distinct values, and the histogram for each attribute. The remaining statistics are straightforward to maintain. Specifically, we omit the derivation of the tuple size, the number of blocks, and index availability. The tuple size of a result is easy to compute from the tuple size(s) of the argument relation(s). The number of blocks is relevant only for base relations and relation-scan algorithms and therefore does not need to be derived for result relations. Index availability need not be derived either because only attributes of base relations are indexed.

3.2 Transfer Operators

The T^{M} operator transfers a relation from the DBMS to the middleware. Its implementation, the TRANSFER^{M} algorithm, is straightforward: it sends an SQL query to the DBMS via the JDBC interface and fetches result tuples.

The performance of this operator depends on the number and size of the tuples transferred. Experiments with Oracle show that the performance is also affected by the row-prefetch setting, which specifies the number of tuples fetched at a time by JDBC to a client-side buffer. We have not included this latter setting in our cost formula because it is DBMS-specific.

The T^{D} operation transfers data from the middleware to the DBMS. Its algorithm, TRANSFER^{D}, first creates a table in the DBMS and then loads data into it. The data load is specific to the DBMS. For example, the program SQL Loader may be used in Oracle. This program needs a data file with the actual tuples and a control file specifying the structure of the data file. An alternative implementation of the T^{D} operation could use a sequence of INSERT statements; this solution would be inefficient for large amounts of data.

In Oracle, a number of optimization techniques can be used to speed up the load time of SQL Loader and to minimize the size of the result table. First, direct-path load can be used (which loads data directly into the database as opposed to conventional-path load which uses INSERT statements). Second, since the size of the data to load is known, the initial memory extent allocated for the table can be equal to that size, avoiding the cost of multiple memory allocations. In addition, blocks of the new table do not have to contain any free space because the table will never be updated.

The cost of TRANSFER^{D} depends on the number and size of the tuples transferred. The name of the table created must be unique, and the table must be dropped at the end of the query.

3.3 Selection

Although DBMSs have efficient selection algorithms, we have also implemented a selection algorithm in the middleware (FILTER^{M}) because it is sometimes needed. For example, if there is a selection between two temporal algorithms to be performed in the middleware, it would be inefficient to transfer the intermediate result to the DBMS solely for the purpose of selection. The cost of FILTER^{M} depends on the relation size as well as on the selection predicate.

Minimum and maximum values of each selection-result attribute are always the same as those of the argument attributes, unless the attribute is involved in the selection predicate so that the predicate forces the minimum value to be increased or the maximum value to be decreased. For example, predicate (A<20) leads to a (new) maximum value that is the minimum of 20 and the old maximum value.

The number of distinct values for a result attribute is equal to the number of equality conditions on the attribute (if there are any), to the old value minus the number of “not equals” conditions on the attribute (if there are any), or is otherwise equal to the old value multiplied by the selectivity of the selection predicate. For example, if the predicate is (A=20 OR A=30), the number of distinct values in the result is 2.

If the selection predicate is non-temporal, the cardinality of the result relation is estimated using standard methods, as in current DBMSs, by either assuming a uniform distribution between the minimum and maximum values or by using histograms and assuming a uniform distribution within each histogram bucket. (A histogram divides attribute values into buckets; each bucket is assigned to a range of attribute values and stores how many attribute values fall within that range.)

Standard estimation techniques are not directly suitable for temporal predicates. Current DBMSs treat time attributes as any other attributes, storing the same statistics. Straightforward use of these statistics leads to very inaccurate estimates of selections having temporal predicates. However, the statistics available from the DBMS are sufficient to adequately estimate the selectivities of such queries. We elaborate on these points next.

Consider a temporal relation R of 100,000 tuples, where the duration of each time period is 7 days and where time periods are uniformly distributed over the period from Jan. 1, 1995 to Jan. 1, 2000. Consequently, the time period start (T1) values are between Jan. 1, 1995 and Dec. 25, 1999, and the time period end (T2) values are between Jan. 8, 1995 and Jan. 1, 2000. Both T1 and T2 may have 1819 distinct values (the number of days between their minimum and maximum values). Each day then has about 383 tuples with an intersecting time period.

Now consider a query that retrieves all tuples overlapping with the period starting on Feb. 1, 1997 and ending on Feb. 8, 1997 (the predicate would be Overlaps(Jan. 2, 1997, Aug. 2, 1997); and its SQL condition may be written as T1<Aug. 2, 1997 AND T2>Jan. 2, 1997). Since the distribution of time periods is uniform, histograms are not needed. The number of tuples in the result should be between 383 and 383·2 tuples, which is about 0.4%-0.8% of the original relation.

To estimate the selectivity of this query, each predicate is analyzed in turn. The first predicate results in 769/1819=42.3% of the original relation, and the second predicate, when applied to the result of the first selection, results in 1064/1819=58.5% of the second relation, which is 24.7% of the tuples of the original relation. This is a factor of 40 too high!

As an alternative to this straightforward estimation, we propose to simply take into account that the end time of a period never precedes its start time, which is a simple application of semantic query optimization. The result cardinality for the above-mentioned query can then be estimated by subtracting EndBefore(A+1, r), the number of tuples ending before or at A (here, Feb. 1, 1997), from StartBefore(B, r), the number of tuples starting before B (here, Feb. 8, 1997).

Functions StartBefore(A, r) and EndBefore(A, r), where A is a time-attribute value in relation r, are defined next. Their definitions depend on whether histograms on T1 and T2 are available. For a given histogram H, functions b1(i, H) and b2(i, H) return the start and end values of bucket i; function bVal(i, H) returns the number of attribute values in the i-th bucket, and function bNo(A, H) return the number of buckets to which attribute value A belongs.

$$\begin{matrix}StartBefore ( A , r ) {=}^{Δ} \{ \begin{matrix}\frac{A - min Val ( T1 , r )}{max Val ( T1 , r ) - min Val ( T1 , r )} \cdot cordinality ( r ) if ⫬ hasHistogram ( T1 , r ) \\ ( {\sum }_{i = 1 , i < b No ( A , T1 )}^{} b Val ( i , T1 ) ) + \frac{A - b1 ( bNo ( A , T1 ) , T1 )}{b2 ( bNo ( A , T1 ) , T1 ) - b1 ( bNo ( A , T1 ) , T1 )} \cdot b Val ( b No ( A , T1 ) , T1 ) otherwise\end{matrix} \\ EndBefore ( A , r ) {=}^{Δ} \{ \begin{matrix}\frac{A - min Val ( T2 , r )}{max Val ( T2 , r ) - min Val ( T2 , r )} \cdot cordinality ( r ) if ⫬ hasHistogram ( T2 , r ) \\ ( {\sum }_{i = 1 , i < b No ( A , T2 )}^{} b Val ( i , T2 ) ) + \frac{A - b1 ( bNo ( A , T2 ) , T2 )}{b2 ( bNo ( A , T2 ) , T2 ) - b1 ( bNo ( A , T2 ) , T2 )} \cdot b Val ( b No ( A , T2 ) , T2 ) otherwise\end{matrix}\end{matrix}$$

To compute these functions using histograms, we find the bucket containing attribute value A. Then we sum the number of values in all preceding buckets and add a fraction of the number of values in the bucket containing A, assuming a uniform distribution of the values within the bucket. The formulas are valid for both height-balanced histograms (where each bucket has the same number of values) and width-balanced histograms (where each bucket is of the same length); functions b1(i, H), b2(i, H), bVal(i, H) would return different values for different types of H.

For the given query, EndBefore(Feb. 2, 1997, R) is 769/1819=42.3% of the original relation, and StartBefore(Aug. 2, 1997, R) is 755/1819=41.5% of the original relation, leading to an estimated size of the result of 0.8% of the original relation, which is close to the actual result.

For a timeslice predicate—such as (T1≦A AND T2>A) which returns all tuples with time periods containing time point A—the result cardinality is StartBefore(A+1, r)—EndBefore(A+1, r).

The proposed estimation technique has some resemblance to a previous proposal, which uses two temporal histograms: one for the starting points of time periods, and one for “active” time periods (a time period is active during a histogram bucket time period P if it starts before P and overlaps with P). The second histogram is not available from current DBMSs. In contrast, we use only statistics maintained by current DBMSs. The formula for Overtaps(A, B) without histograms follows given estimation techniques.

3.4 Temporal Join

Temporal join ( [symbol] ^{T}) joins tuples that have equal join attributes and overlapping time periods. Time attributes T1 and T2 contain the intersection period in the result. DBMSs have efficient join algorithms, but there are cases when temporal join can be performed more efficiently in the middleware.

We consider a straightforward temporal join algorithm, TJOIN^{M}, which takes two relations sorted on the join attribute and merges them, comparing the time-attribute values. More efficient algorithms could be used, but the current algorithm is sufficient to illustrate the functioning of TANGO. The cost formula for the algorithm is given in FIG. 6.

In the DBMS, temporal join is implemented by regular join, selection, and projection (see Section 3.6).

When estimating the selectivity of a temporal join, we use the following assumptions: the lifespans of relations to be joined are identical, the values of join attributes are uniformly distributed, the time periods for these values are uniformly distributed throughout the entire lifespan, and there is a referential integrity constraint on the values (for each join-attribute value of the referenced relation, there is a corresponding value in the referencing relation). With these assumptions, we derive that the cardinality of r₁ [symbol] _{jα}_{₁}_{=jα}_{₂}^{T} r₂ is

min(distinct(jα₁,r₁), distinct(jα₂,r₂)) OverlapingPeriods,

where OverlappingPeriods is the number of overlapping periods for each pair of equal values of jα₁ and jα₂. We also derive that the minimum and maximum bound, respectively, of OverlappingPeriods is

$$max ( \frac{cardinality ( {r}_{1} )}{distinct ( j {α}_{1} , {r}_{1} )} , \frac{cardinality ( {r}_{2} )}{distinct ( j {α}_{2} , {r}_{2} )} ) and \frac{cardinality ( {r}_{1} )}{distinct ( j {α}_{1} , {r}_{1} )} + \frac{cardinality ( {r}_{2} )}{distinct ( j {α}_{2} , {r}_{2} )} - 1.$$

Since, in experiments, we use data with irregularly occurring updates, we chose to use the minimum bound plus 80% of the difference between the maximum and minimum bounds. The selectivity estimation technique used corresponds to the one presented in prior art.

3.5 Temporal Aggregation

Temporal aggregation (ξ^{T}) is one of those operators that clearly benefit from running in the middleware versus in the DBMS. We have implemented a middleware implementation, TAGGR^{M}, and a DBMS implementation, TAGGR^{D}, which is a 50-line SQL query. FIG. 7(a) gives an example of temporal aggregation SQL query computing the COUNT aggregate for the POSITION relation. While it is possible to write this query in a more compact way (in about 25 lines, using views), to our knowledge, the provided code yields the best performance¹. Below we discuss TAGGR^{M} as well as how the result cardinality is derived.

For TAGGR^{M}, we require its argument to be sorted on the grouping attribute values and on T1, because if tuples of the same group are scattered throughout the relation, aggregate computation requires scanning of the whole relation for each group. Meanwhile, if the argument is ordered on the grouping attributes, only a certain part of the argument relation is needed at a time. The sorting enables reading each tuple only once.

In addition, another copy of the argument is sorted on all grouping attributes and T2. The first sorting is performed by an external algorithm (SORT^{M} or SORT^{D}), while the second sorting is performed internally by the TAGGR^{M} algorithm. The algorithm traverses both copies of the argument similarly to sort-merge join and computes the aggregate values group by group. FIG. 7(b) outlines its pseudo-code for computing the COUNT aggregate; the code has to be modified slightly for computing other aggregates. The algorithm is different from the temporal aggregation algorithms presented in prior art, which used aggregation trees in memory or, during computation, maintained lists of constant periods and their running aggregate values.

The cost of temporal aggregation in the middleware depends on the size of the argument and of the result (see FIG. 6). For simplicity, the complexity of the actual aggregate functions (such as MIN or AVG) is not included, but experiments show that different such functions do not change the cost significantly. The cost of internal sorting is accounted for.

The upper bound for the cardinality of ξ_{G}^{T}_{₁}_{, . . . , G}_{ₙ}_{, F}_{₁}_{, . . . , F}ₘ(r) is cardinality(r)·2−1, and the lower bound (for a non-empty relation) is 1. Knowing the number of distinct values for the grouping and the time attributes allows us to tighten the range between the minimum and maximum.

The minimum cardinality is min(distinct(Gᵢᵣ r), . . . , distinct(Gₙ r), distinct(T1, r)+1, distinct(T2, r)+1). If there are no grouping attributes, the maximum cardinality is distinct(T1, r)+distinct(T2, r)+1. Otherwise, it is

$$( \frac{cardinality ( r )}{max ( distinct ( {G}_{1} , r ) , … , distinct ( {G}_{n} , r ) )} \cdot 2 - 1 ) \cdot max ( distinct ( {G}_{1} , r ) , … , distinct ( {G}_{n} , r ) ) ,$$

where the fraction represents the average number of tuples for each value of the grouping attribute having the most distinct values, and the factor to the right represents the maximum number of the resulting time periods for each such value. We multiply it by the maximum number of distinct values for the grouping attributes. For experiments, we use 60% of the maximum cardinality if the resulting value is bigger than the minimum cardinality, and the minimum cardinality, otherwise.

3.6 Other Operations

The middleware optimizer effectively assumes that one “generic” join algorithm is used in the DBMS (JOIN^{D}), because it cannot know which join strategy will actually be employed for a given query. We have also implemented a sort-merge join algorithm JOIN^{M} for the middleware. Similarly, we have one DBMS algorithm and one middleware algorithm for projection (PROJECT^{D} and PROJECT^{M}). Meanwhile, Cartesian product can only be performed in the DBMS (by PRODUCT^{D}).

For sorting, the middleware uses Java's native sorting algorithm, which is a modified merge sort that offers guaranteed n·log₂n performance. The cost formulas for the sorting algorithms in the middleware and the DBMS (SORT^{M} and SORT^{D}), as well as for the above-mentioned algorithms, are given in FIG. 6.

For relation scans, we use two algorithms: FULLSCAN^{D} and INDEXSCAN^{D}. We assume that the latter is used if the scan is followed by a selection on an indexed attribute. The cost of INDEXSCAN^{D} depends on whether the index is clustered or not (parameters Pᵢₙₛ_{₁}, and Pᵢₙₛ_{₂} in its cost formula in FIG. 6 are likely to be different). However, if the estimated computed cost of INDEXSCAN^{D} is bigger than that of FULLSCAN^{D}, we use the latter cost because it is likely that the DBMS will not use the index. Note that both algorithms are translated into the same SQL code; the usage of two algorithms just helps to better estimate the total cost of the query.

4 Query Optimization Heuristics and Equivalences

Initial query plans have a single T^{M} operator at the top, assigning all processing to the DBMS. TANGO's optimizer applies transformation rules to generate candidate query plans. In this section, we outline the transformation rules that drive this process.

Transformation rules derive from equivalences that express that the relations that result from two algebraic expressions are in some sense equal. Specifically, we use two kinds of equivalences, list equivalences and multiset equivalences. Two expressions are list equivalent if they evaluate to relations that are equal as lists, and are multiset equivalent if they evaluate to relations that are equal as multisets. This latter notion of equal takes into account duplicates, but not order.

List equivalence implies multiset equivalence, and for each transformation rule given below, we only explicitly give the strongest equivalence type that holds. We denote left-to-right transformation rules (also termed heuristics) by→_{L} or →_{M} and bidirectional transformation rules by ≡_{L} or ≡_{M}.

These two types of equivalence are essential in a middleware architecture because the location where an operation is processed affects the type of equivalence that holds: while the middleware algorithms are designed to be order preserving, this does not hold for the DBMS algorithms. Therefore, applying a→_{L} rule means that if (1) the relation produced by the left-hand side has some specified order and (2) if it is located in the middleware or if the top operation at the left-hand side is sorting, then the relation produced by the right-hand side will have the same order as the relation produced by the left-hand side. But if either of these two conditions does not hold, only multiset equivalence may be assumed.

4.1 Heuristics

We divide the heuristics into four groups, based on their intended function, and we discuss them in turn

Heuristic Group 1 Move to the middleware only those operations that may be processed more efficiently there.

An operation is moved to the middleware by introducing the T^{M} operation below it and the T^{D} operation above it. Experiments with different DBMSs show that the operations that may benefit from being processed by the special-purpose algorithms in the middleware are temporal aggregation, join, and temporal join. Transformation rules T1-T3 accomplish this move. Note that these rules introduce the sort operator because the algorithms that implement these operations in the middleware require sorted arguments (temporal join and join are implemented as sort-merge joins). In addition, we use rules that enable moving selection, projection, and sorting to the middleware (rules T4-T6); we do not introduce extra T^{M} and T^{D} operations in these rules because these operations alone cannot be the reason to partition the processing. Rule T6 has type →_{L} because operation T^{M} preserves order.

ξ_{G}^{T}_{₁}_{, . . . , G}_{ₙ}_{,F}_{₁}_{, . . . , F}_{ₘ}(r)→_{M}T^{D}(ξ_{G}^{T}_{₁}_{, . . . , G}_{ₙ}_{,F}_{₁}_{. . . , F}_{ₘ}(T^{M}(sort_{G}_{₁}_{, . . . , G}_{ₙ}(r)))) (T1)

^{r}1 [symbol] _{jα}_{₁}_{,jα}_{₂}r₂→_{M}T_{D}(T^{M}(sort_{jα}_{₁}(r₁)) [symbol] _{jα}_{₁}_{,jα}_{₂}T^{M}(sort_{jα}_{₂}(r₂))) (T2)

^{r}1 [symbol] _{jα}_{₁}_{,jα}_{₂}^{T}r₂→_{M}T^{D}(T^{M}(sort_{jα}_{₁}(r₁)) [symbol] _{jα}_{₁}_{,jα}_{₂}^{T}T^{M}(sort_{jα}_{₂}(r₂))) (T3)

T^{M}(σ_{P}(r))→_{M}σ_{P}(T^{M}(r)) (T4)

T^{M}(π_{f}_{₁}_{, . . . , F}_{ₙ}(r))→_{M}π_{f}_{₁}_{, . . . , f}_{ₙ}(T^{M}(r)) (T5)

T^{M}(sort_{A}(r))→_{M}sort_{A}(T^{M}(r)) (T6)

Rules T1-T3 are applied only if the top operators of their left-hand sides are assigned to processing in the DBMS. In these and all subsequent rules, r may be a base relation or an operation tree (query expression).

Heuristic Group 2 Eliminate redundant operations.

This group includes rules for removing sequences of T^{M} and T^{D} operations (caused be multiple applications of rules T1-T3), and unnecessary projection and sort operations. A sorting operation can be removed if its argument is already ordered as needed, or if only multiset equivalence is required (this may happen, for example, if, the relation will be sorted later, or if the end result does not need to be ordered). For each given heuristic, we specify its pre-condition (if any) following the heuristic.

T^{M}(T^{D}(r))→_{M}r (T7)

T^{D}(T^{M}(r))→_{M}r (T8)

π_{f}_{₁}_{, . . . , f}_{ₙ}(r)→_{L}r {f₁, . . . , fₙ}=Ω, (T9)

sort_{A}(r)→_{L}r IsPrefixOf(A, Order(r)) (T10)

sort_{A}(r)→_{M}r (T11)

sort_{A}(sort_{B}(r))→_{L}sort_{A}(r) IsPrefixOf(B, A) (T12)

Rule T9 can be applied for projections on all attributes of the argument relation. We denote the attribute domain of the schema of relation r by Ωᵣ₁. Predicate IsPrefixOf takes two lists as argument and returns True is the first is a prefix of the second.

Heuristic Group 3 Combine several operations into one.

The main examples of this group include combining Cartesian products and selections into a join or a temporal join. In addition, two selections or projections can be combined into one.

σ_{jα}_{₁}_{=jα}_{₂}(r₁×r₂)→_{M}r₁ [symbol] _{name(jα}_{₁}_{)=name(jα}_{₂}₎r₂ name(jαᵢ)εΩᵣ_{₁},i=1,2 (T13)

σ_{jα}_{₁}_{=jα}_{₂} _{1.T1<2.T2 1.T2>2.T1} [symbol] [symbol](r₁×r₂)→_{M}r₁ [symbol] _{name(jα}_{₁}_{)=name(jα}_{₂}₎^{T}r₂ name(jαᵢ)εΩᵣ_{₁}, i=1,2 (T14)

σ_{P}_{₁}(σ_{P}_{₂}(r))→_{L}σ_{P}_{₁} _{P} [symbol]_{₂}(r) (t15)

π_{f}_{₁}_{, . . . , f}_{ₙ}(πₕ_{₁}_{, . . . , h}_{ₘ}(r))→_{L}π_{f}_{₁}_{, . . . , f}_{ₙ}(r) attr(f₁, . . . , fₙ)⊂Ωᵣ (T16)

If both arguments of a Cartesian product have an attribute with the same name, we prefix these by “1.” and “2.” in the result. Function name, when applied to an attribute in the result of a binary operation, returns the attribute's name without its prefix, if there was any.

Heuristic Group 4 Reduce sizes of arguments to expensive operations (introducing new operations, if necessary).

This group includes rules that reduce the sizes of the arguments to computationally expensive operations, including temporal aggregation, join, and temporal join. For example, projection on the grouping, aggregate, and time attributes can be applied to the argument of a temporal aggregation (rule T17).

ξ_{G}^{T}_{₁}_{, . . . , G}_{ₙ}_{,F}_{₁}_{, . . . , F}_{ₘ} (r)→_{L}ξ_{G}^{T}_{₁}_{, . . . , G}_{ₙ}_{, F}_{₁}_{, . . . , F}_{ₘ}(π_{A}_{₁}(r)), where A₁={α|αε{G₁, . . . , Gₙ} [symbol] αεattr(F₁, . . . , Fₙ) [symbol] αε{T1,T2}} (T17)

σ_{P}(ξ_{G}^{T}_{₁}_{, . . . , G}_{ₙ}_{, F}_{₁}_{, . . . , F}_{ₘ}(r))→_{L}ξ_{G}^{T}_{₁}_{, . . . , G}_{ₙ}_{, F}_{₁}_{, . . . , F}_{ₘ}(σ_{P}(r)) attr (P) ⊂{G₁, . . . , Gₙ} (T18)

σ_{P}(ξ_{G}^{T}_{₁}_{, . . . , G}_{ₙ}_{, F}_{₁}_{, . . . , F}_{ₘ}(r))→_{L}σ_{P}(ξ_{G}^{T}_{₁}_{, . . . , G}_{ₙ}_{, F}_{₁}_{, . . . , F}_{ₘ}(σ_{P}(r))) attr(P) {G₁, . . . , Gₙ} [symbol] attr(P)⊂{G₁, . . . , Gₙ,T1,T2} (T19)

σ_{P}(r₁ op r₂)→_{M}σ_{P}(r₁) op r₂ op ε{x, [symbol] , [symbol] ^{T}} [symbol] attr(P)⊂Ωᵣ_{₁} (T20)

σ_{P}(r₁ op r₂)→_{M}r₁op σ_{P}(r₂) op ε{x, [symbol] , [symbol] ^{T}} [symbol] attr(P)⊂Ωᵣ_{₂} (T21)

π_{f}_{₁}_{, . . . , f}_{ₙ}(r₁ [symbol] _{jα}_{₁}_{=jα}_{₂}r₂)→_{L}π_{f}_{₁}_{, . . . , f}_{ₙ}(π_{A}_{₁}(r₁) [symbol] _{jα}_{₁}_{=jα}_{₂}π_{A}_{₂}(r₂)), where A₁={α|αεattr(f₁, . . . , fₙ) [symbol] αεΩᵣ_{₁}}, A₂={α|αεattr(f₁, . . . , fₙ) [symbol] αεΩᵣ_{₂}} (T22)

π_{f}_{₁}_{, . . . , f}ₙ(r₁ [symbol] _{jα}_{₁}_{=jα}_{₂}^{T}r₂)→_{L}π_{f}_{₁}_{, . . . , f}_{ₙ}(π_{A}_{₁}(r₁) [symbol] _{jα}_{₁}_{=jα}_{₂}^{T}πA₂(r₂)), where

A₁={α|(αεattr(f₁, . . . , fₙ) [symbol] αεΩᵣ_{₁}) [symbol] αε{T1,T2}}

A₂={α|(αεattr(f₁, . . . , fₙ) [symbol] αεΩᵣ_{₂}) [symbol] αε{T1,T2}} (T23)

π_{f}_{₁}_{, . . . , f}ₙ(σ_{P}(r))→_{L}π_{f}_{₁}_{, . . . , f}_{ₙ}(σ_{P}(π_{A}_{₁}(r))), where attr(P) attr(f₁, . . . , fₙ) A₁={αε attr(f₁, . . . , fₙ) [symbol] αε attr(P)}(T24)

The pre-condition for rule T24 is necessary because the rule should be applied only when the selection condition includes attributes that are not projected by the top projection of the left-hand side; otherwise, equivalence E1 should be used. Note that this rule is only useful when it triggers the application of some other rules, such as T22 and T23.

All rules in this group can be applied only once for a given subtree, to prevent infinite addition of new operations.

4.2 Equivalences

In addition to the uni-directional heuristics given above, a number of bi-directional equivalences are employed, including moving selections and projections down or up the operation tree and switching the order of Cartesian products. We make pre-conditions that apply only for the left-to-right and right-to-left transformation by [1r] and [r1], respectively.

π_{f}_{₁}_{, . . . , f}ₙ(σ_{P}(r)) ≡_{L}σ_{P}(π_{f}_{₁}_{, . . . , f}_{ₙ}(r)) [1r] attr(P)⊂ attr(f₁, . . . , fₙ) (E1)

r₁ op r₂≡_{M} r₂ op r₁ op ε{x, [symbol] , [symbol] ^{T}} (E2)

(r₁ op r₂) op r₃≡_{M} r₁ op (r₂ op r₃) op ε{x, [symbol] [symbol] ^{T}} (E3)

sort_{A}(σ_{P}(r)) ≡_{L}σ_{P}(sort_{A}(r)) (E4)

sort_{A}(πf_{₁}_{, . . . , f}ₙ(r))≡_{L}π_{f}_{₁}_{, . . . , f}ₙ(sort_{A}(r)) [1r] attr(P) ⊂Ωᵣ, [r1] attr(P) ⊂ attr(f₁, . . . , fₙ) (E4)

Function attr returns the set of attributes present in projection functions or in a selection predicate. Equivalences E4 and E5 are used only when their left-hand side operations are processed in the middleware. Because equivalent query parts assigned to processing in the DBMS are subsequently translated into the same SQL code, it is useful to apply transformation rules to the DBMS parts only when this may help the middleware optimizer to more accurately estimate their costs. Consequently, applicable rules include, e.g., introduction of extra projections or selections. Pushing sorting down or up does not help the optimizer.

5 Performance Studies

To validate TANGO, we conducted a series of performance experiments. Objectives of the experiments and the data used are described in Section 5.1. Section 5.2 briefly discusses how the cost factors were determined, and Section 5.3 describes in detail the optimization and processing of four queries. Section 5.4 summarizes performance study findings.

5.1 Objectives and Context

We set a number of objectives for performance experiments. First, we wanted to determine if and when it is worth processing fragments of queries in the middleware, and where and when the different operations should be evaluated. In addition, we wanted to evaluate the robustness of the middleware optimizer, i.e., does it return plans that fall within, say, 20% of the best plans. We also attempted to validate the advantages of cost-based optimization, including the proposed selectivity estimation technique for temporal selections. Finally, we sought to determine how significant the overhead of TANGO is.

We performed a sequence of queries, where each query aims to answer a number of the above-mentioned questions. The queries were run on realistic dataset from a university information system. Specifically, two relations were used, namely EMPLOYEE, which maintains information about employees, and POSITION, part of which was used in Section 2.1 and which provides information on job assignments to employees. The first relation has 49,972 tuples of 31 attributes (about 13.8 megabytes of data) and the second relation has 83,857 tuples of 8 attributes (about 6.7 megabytes of data). We have also used eight other variants of POSITION with, respectively, 8,000, 17,000, 27,000, 36,000, 46,000, 55,000, 64,000, and 74,000 tuples from the original relation.

All queries were optimized using the middleware's optimizer and then run via its Execution Engine. All running times in the graphs are given in seconds; for query plans involving middleware algorithms, the middleware optimization time is included. To enable optimization in the middleware, we collected statistics on the (DBMS) relations used via the Statistics Collector module, and we calibrated the cost factors in the cost formulas via the Cost Estimator module; the latter procedure is described next.

5.2 Determining Cost Factors

We ran a set of test queries on EMPLOYEE and POSITION, measuring elapsed times, which are then used to determine the cost factors used in the cost formulas.

The calibration mechanism is similar to that of Du et al., with some differences. They apply test queries to a synthetic database, which is constructed to make the query plans for the test queries predictable, and to avoid distorting effects of storage implementation factors such as pagination. In contrast, we opted to use a real database because our middleware optimizer works in a setting that neither enables it to know the physical characteristics of the data nor the specific plans that are chosen by the DBMS. Because of the limited information available to us, we use less precise cost factors and formulas. For example, we assume that a single DBMS algorithm for join is always used. As we show in the performance studies, this simplified approach is effective in successfully dividing the query processing between the middleware and the underlying DBMS.

The middleware cost estimator has separate modules that determine the cost factors for the DBMS algorithms versus the middleware algorithms. For the former, since even the simplest query contains a relation or index scan and a transfer of the results from the DBMS server to the client, we employed a bottom-up strategy: we first determined the cost factors for result transfers and relation scans. Then, for each other algorithm, we used a query involving that algorithm, relation scan, and result transfer. For simplicity, we assumed zero cost for selections and projections.

The cost factors for the middleware algorithms are generally easier to deduce because, for each algorithm, we are able to measure directly the running times of its init() and getNext() routines. Only the TRANSFER^{M} cost factor must be determined differently, since each TRANSFER^{M} involves both the processing in the DBMS of the query given as its parameter and the transfer of the result to the middleware. For each TRANSFER^{M}, we measured the elapsed time of its query when run solely in the DBMS and then subtracted it from the total cost of TRANSFER^{M} to obtain the actual transfer cost.

5.3 Queries

We have examined closely the plans for a number of queries to ensure that the optimizer identifies the portions of queries that are appropriate for execution in the DBMS and in the middleware. Here, we consider five such queries in some detail. For each, we show several of the plans that were enumerated by the optimizer, and we measure the evaluation time for these selected plans over a range of data. In most cases, the optimizer does select the best plan among the enumerated ones; we elaborate on how it does so.

The Volcano optimizer is based on a specific notion of equivalence class. Each equivalence class represents equivalent subexpressions of a query, by storing a list of elements, where each element is an operator with pointers to its arguments (which arc also equivalence classes). The number of equivalence classes and elements for a query directly correspond to the complexity of the query; we give these measures for each query.

Query 1 “For each position in POSITION, get the number of employees occupying that position at each point of time. Sort the result by the position number.”

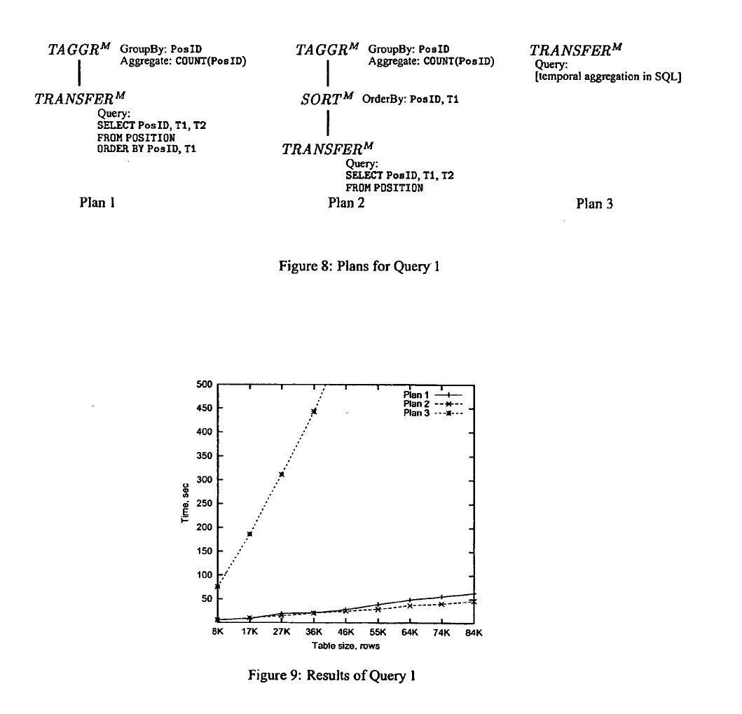

This temporal aggregation query was used as subquery in the example query in Section 2.2. FIG. 8 shows three of the query evaluation plans for this query. The first sorts the base relation in the DBMS on the grouping attribute and the starting time, then performs the temporal aggregation in the middleware. Since TAGGR^{M} preserves order on the grouping attributes, additional sorting is not needed at the end. The second plan is similar, but performs sorting in the middleware. The third performs everything in the DBMS. Due to space constraints, we omit the complete SQL query here.

We compare the three plans for varying sizes of the argument relation. For all queries, the optimizer selects the first plan. The optimizer generated 12 equivalence classes with 29 class elements.

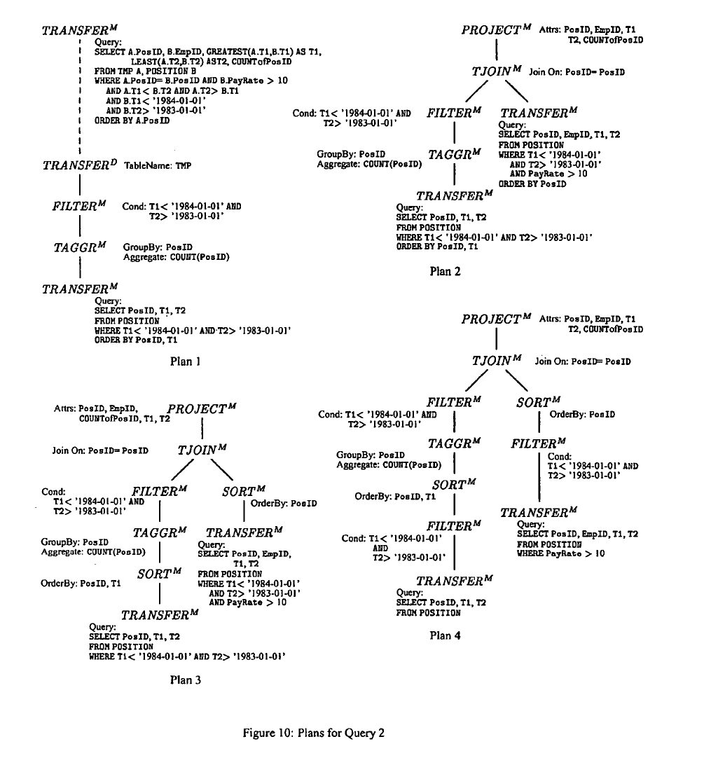

The running times of all plans are shown in FIG. 9, where it can be seen that the first two significantly outperform the third. This is because temporal aggregation in the DBMS is very slow. While not reported here, experiments with similar queries, where the the grouping attribute(s) and relation size are also varied, show similar results.

This experiment shows that processing in the middleware can be up to ten times faster, if a query involves temporal aggregation. Temporal aggregation in the DBMS can compete with temporal aggregation in the middleware only when a very small number of records (a few hundreds) have to be aggregated (see Query 2).

Query 2 “Produce a time-varying relation that provides, for each POSITION tuple with pay rate greater than $10, the count of employees that were assigned to the position. Consider the time period between Jan. 1, 1983 and Jan. 1, 1984 and sort the result by position number.”

This query corresponds to the query presented in Section 2.2, but we introduce the time period and the $10 pay rate condition.

Six plans were used, four of which are given in FIG. 10. The first plan performs temporal aggregation in the middleware and the rest in DBMS. The next three plans also assign temporal join to the middleware (Plan 2); temporal join and sorting to the middleware (Plan 3); and temporal join, sorting, and selection to the middleware (Plan 4). The fifth plan (not shown) is the same as the first, but no selection is performed on the argument to the temporal aggregation (this selection is not needed for correctness, but it reduces the argument size). The sixth plan (not shown) performs everything in the DBMS.

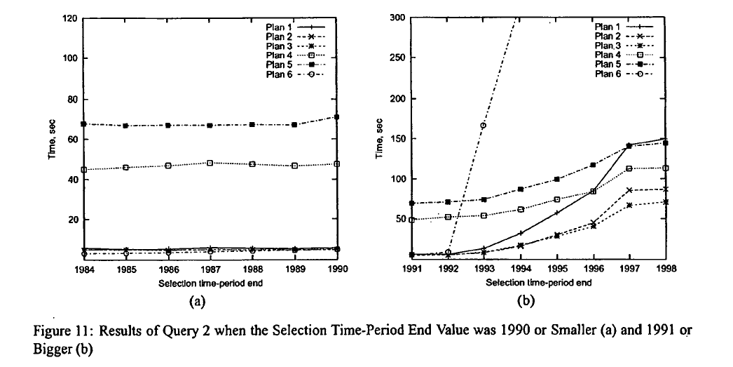

We ran all six plans a number of times, each time increasing the end time of the time period given in the query by one year, thus relaxing the predicate. Since most of the POSITION data is concentrated after 1992, the running times are similar for the queries with the time period ending before 1992 (see FIG. 11), but they increase rapidly after that time (see FIG. 11(b)). In FIG. 11(a), we also observe that Plans 4 and 5 perform poorly; this is because of the high cost of the TRANSFER^{M} operation, which takes the whole base relation as its argument (without applying selection first). Plan 6, which performs temporal aggregation in the DBMS, is competitive because the selection predicates are very selective.

For larger time periods (FIG. 11(b)), the performances of the plans vary more. Plans 4 and 5 are slow due to the expensive TRANSFER^{M} operations, and Plan 6 also deteriorates rapidly when the argument to the temporal aggregation increases. Plan 1 deteriorates faster than Plans 2 and 3 because it includes the TRANSFER^{D} algorithm, which becomes significantly slower when its argument's size increases (due to the increase of the selection time period).

We optimized this query running the middleware optimizer with and without histograms on the time attributes. When used without histograms, the optimizer returned the second plan for the six queries with the time-period end varying from Jan. 1, 1984 to Jan. 1, 1989, and the first plan for all other queries. When used with histograms, the optimizer always returned the second plan (which is better than the first plan, as is clear from FIG. 11(b)), because it could more accurately estimate the result size of the temporal selection. The optimizer generated 142 classes with 452 elements in total.

This query shows that temporal join can be as much as two times faster in the middleware if at least one of its arguments resides there (as does, in this case, the result of temporal aggregation). Query 4 shows that the same holds for regular join. In addition, this experiment confirms that the cost-based selectivity estimation helps the middleware optimizer return better plans.

Query 3 “For each position in POSITION starting before Jan. 1, 1990, show all pairs of employees that occupied that position during the same time. Sort the result by the position number.”

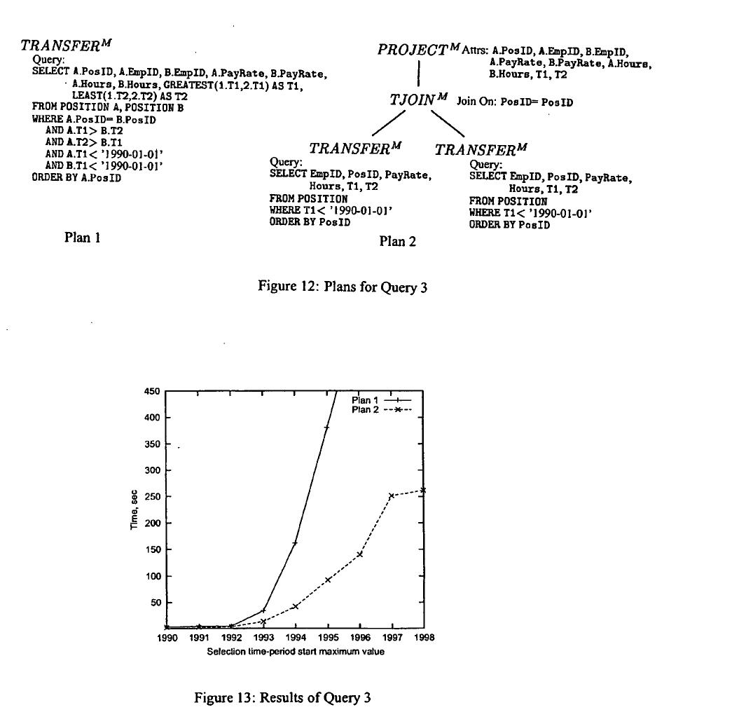

This query is a temporal self-join. We tested two plans: the first performs everything in the DBMS, while the second performs temporal join in the middleware. FIG. 12 shows two possible plans: the first performs everything in the DBMS, while the second performs temporal join in the middleware. In the experiment, we have varied the condition constraining the time-period start. The running times are shown in FIG. 13.

When the maximum allowed time for the time-period start increases, Plan 2 performs better than Plan 1 because the result is bigger than the arguments, leading to high costs of sorting within the DBMS and transfer of the result in Plan 1. The difference in performance becomes obvious when the maximum time-period start reaches year 1996, since about 65% of the POSITION tuples have time-periods starting at 1995 or later.

The middleware optimizer returned Plan 1 for the first six queries and Plan 2 for the last three. The errors for the middle three queries—where Plan 2 is already better than Plan 1—occur because the selectivity estimation for join and temporal join assumes uniform distribution of the join-attribute values (POsID), which is not the case for the data used. The optimizer generated 104 equivalence classes with 301 element.

This query illustrates that allocating processing (in this case, of temporal join) to the middleware can be advantageous if the result size is bigger than the argument sizes. It also demonstrates that the cost-based optimization leads to selecting a better plan for the last three queries.

Query 4 “For each employee, compute the number of positions that he or she occupied over time between Jan. 1, 1996 and Jan. 1, 1997. Sort the result by the employee ID.”

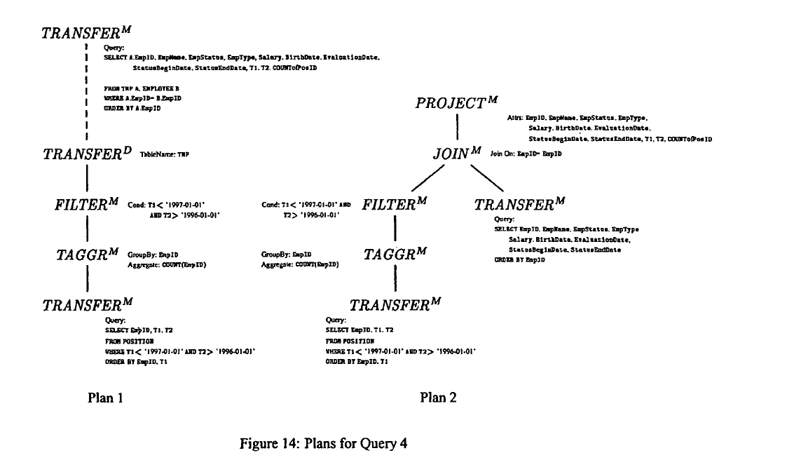

This query involves temporal aggregation on EmpID and a regular join of EMPLOYEE and POSITION. FIG. 14 shows the first two plans used; the three other plans used may be easily understood in terms of these. The first plan performs temporal aggregation in the middleware and the rest in the DBMS. The second performs both temporal aggregation and join in the middleware, and the third plan performs temporal aggregation, join, and selection in the middleware. The fourth plan is similar to the first plan, but does not perform the initial selection before temporal aggregation, and the fifth plan performs everything in the DBMS. We ran the plans, varying the size of the POSITION relation.

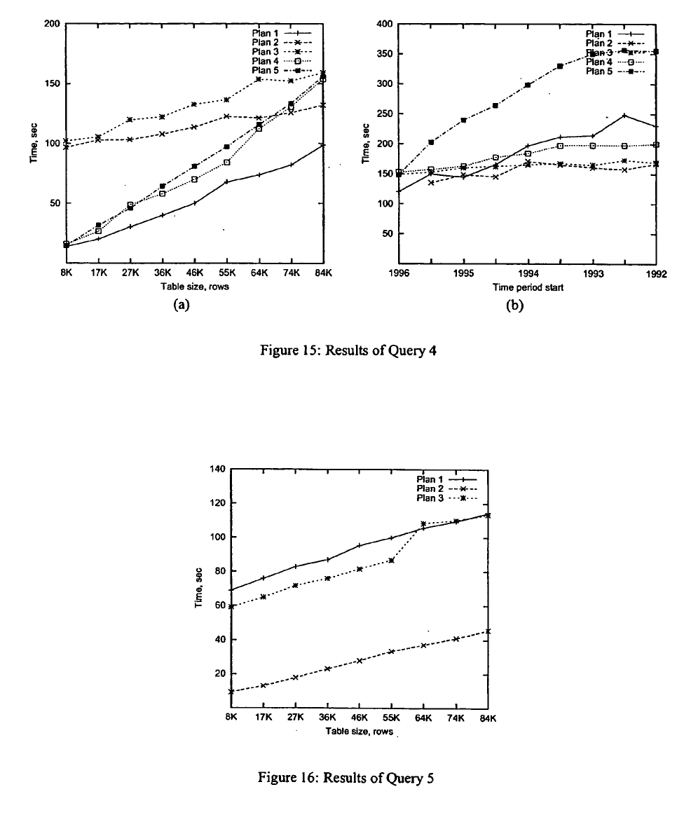

The results in FIG. 15(a) show that the first plan outperforms the others. This is because the join is faster in the DBMS and it does not require sorted arguments as the JOIN^{M} algorithm. In addition, TRANSFER^{D} is not very expensive because the cardinality of its argument is small due to the temporal selection, meanwhile, the extra TRANSFER^{M}'s in Plans 3 and 4 are rather expensive since they retrieve many tuples from the DBMS that are rejected by the FILTER^{M} algorithm. For all queries, the middleware optimizer returned Plan 1. It generated 43 equivalence classes and 85 elements.

We also ran the plans varying the time-period start; the results are shown in FIG. 15(b). The performance of Plan 1 becomes worse than the performance of Plan 2 because TRANSFER^{D} becomes more expensive. The middleware optimizer still returned Plan 1 for all queries because—as for Query 3—the join-attributes did not follow a uniform distribution, as assumed by join selectivity derivation formula.

The experiment shows that, in some cases, the middleware can also be used for processing regular DBMS operations.

Query 5 “For each position, list the employee name and address.”

This query is a regular join of the POSITION and EMPLOYEE relations. We tested three plans: the first plan performs sorting and join in the middleware, the second plan performs a nested-loop join in the DBMS, and the third plan performs a sort-merge join in the DBMS (the DBMS join methods were set explicitly using Oracle hints). We executed the plans while varying the size of the POSITION relation. The results in FIG. 16(b) show that Plan 2 yields the best performance while the other two plans are competitive. The middleware optimizer suggested to perform the join in the DBMS (plans 2 and 3; since the optimizer does not consider different DBMS join algorithms, both plans were considered as one). It generated 13 equivalence classes with 30 elements in total.

This experiment shows that the DBMS is faster when performing queries involving regular operations. The fact that similar algorithms are competitive in the DBMS and middleware (both plans 1 and 3 include sort-merge joins) indicates that the run-time overhead introduced by TANGO is insignificant.

5.4 Summary of Performance Study Findings

The performance experiments demonstrate that the middleware can be very effective when processing queries involving temporal aggregation. Temporal join is faster in the middleware if at least one its arguments already resides there (Query 2), or if its result size is bigger than its argument sizes (Query 3); other experiments not reported here show that there are cases when temporal join is more efficient in the DBMS.

In addition, we showed that the cost-based optimization with its simplified cost formulas is effective in dividing the processing between the middleware and the DBMS. The proposed selectivity estimation techniques for temporal selection was shown to more accurately estimate sizes of intermediate relations, which generally results in better plans being selected. Plans allocating all evaluation for the DBMS (including temporal aggregation) perform well for highly selective queries, but deteriorate rapidly as selection predicates are relaxed (FIG. 11(b)).

For the tested queries, the middleware optimization overhead was very small. We have not implemented the parser and Translator-To-SQL middleware modules, but we do not expect them to significantly slow down the processing. They will use standard language technology and are independent of the database size. It should be noted, though, that we have not tested queries involving many joins; for such queries, it is likely that join-order heuristics should be introduced instead of the join equivalences used (Section 4.2).

6 Related Work

The general notion of software external to the DBMS participating in query processing is classic. Much work has been done on heterogeneous databases (also called federated databases or multidatabases), in which data resident in multiple, not necessarily consistent databases is combined for presentation to the user . This approach shares much with the notion of temporal middleware: the underlying database cannot be changed, the data models and query languages exposed to the users may differ from those supported by the underlying databases, the exported schema may be different from the local schema(s), and significant query processing occurs outside the underlying DBMS. However, there are also differences. A heterogeneous database by definition involves several underlying databases, whereas the temporal middleware is connected to but one underlying database. Hence, in heterogeneous databases, data integration, both conceptually and operationally, is a prime concern; this is a non-issue for temporal middleware.

More recently, there has been a great deal of work in the related area of mediators and, more generally, on integration architectures. Roughly, a mediator offers a consistent data model and accessing mechanism to disparate data sources, many of which may not be traditional databases. As such, the focus is on resolving schema discrepancies, semi-structured data access, data fusion, and efficient query evaluation in such a complex environment. Again, there are differences between mediators and temporal middleware; the latter does not address issues of data fusion and schematic discrepancies, or of access to semi-structured data. The two approaches, though, share an emphasis on interposing a layer (also termed a wrapper) that changes the data model of the data, or allows new query facilities to access the data. Also shared is an emphasis on domain specialization.

While the architecture of a temporal middleware is similar at an abstract level to that of a DBMS, the transformation rules, cost parameters, and internal query evaluation algorithms are very different.

Several specific related works utilize an integration architecture. The Garlic system offers access to a variety of data sources, with very different query capabilities. This mediator employs sophisticated cost-based optimization, based on the Starburst optimizer. Notably, the optimizer attempts to push selections, projections, and joins down to the data sources. To do so, it assumes a fixed schema at each data source. The source wrappers require careful calibration and are closely coupled with their sources. In contrast, our approach assumes a single data source supporting the full features of SQL, including schema definition statements. We do not assume that if an operation can be done in a data source, that is best; rather, we permit some query evaluation in the temporal middleware when it is more efficient to do so.

Capabilities-based query rewriting also assumes that the data sources vary widely in their query capabilities. Here, attention focuses on capturing the capability of each source, and on using this information in query rewriting. This approach, unlike that just described, is schema independent.

Gravano et al. offer a toolkit that allowed wrappers to be automatically generated from high-level descriptions. This approach assumes a specific schema, as well as a fixed query language. In contrast, our approach does not fix the schema. Similarly, prior art is concerned with wrapper implementation over diverse data sources; they also fix the schema, and focus on relational projection, selection, and join. Our approach assumes that the underlying database is capable of most, or all, of the processing (though it may not be appropriate for the data source to actually evaluate the entire temporal query).

Other mediator systems, e.g., OLE DB and DISCO, are similar in their emphases on data integration and access to weak data sources (those with less powerful query facilities). We view mediator approaches as complementary to the temporal middleware approach introduced here. For integrating across diverse data sources, the mediator approach is appropriate. Given such an architecture, a temporal middleware can then be interposed either between the user and the mediator, or between the wrapper and the underlying database. In this way, coarse-grained query processing decisions can be made via the cost-based optimization discussed in Sections 3-4, with more conventional cost-based (and perhaps capabilities-based) optimization making more fine-grained decisions.

Several papers discuss layered architectures for a temporal DBMS, and several prototype temporal DBMSs have been implemented. That work is mainly based on a pure translation of temporal query language statements to SQL and does not provide systematic solutions on how to divide the processing of temporal query language statements between the stratum and the underlying DBMS. Vassilakis et al. discussed techniques for adding transaction and concurrency control support to a layered temporal DBMS; their proposed temporal layer always sends regular operators to the DBMS processing and is able to evaluate temporal operators at the end of a query, if needed. Our proposed optimization and processing framework is more flexible.

The present invention extends our previous foundation for temporal query optimization, which included a temporal algebra that captured duplicates and order, defined temporal operations, and offered a comprehensive set of transformation rules. However, that foundation did not cover optimization heuristics, the implementation of temporal operations, or their cost formulas, which are foci of the present invention. Other work on temporal query optimization primarily considers the processing of joins and semijoins. Perhaps most prominently, Gunadhi and Segev define several kinds of temporal joins and discuss their optimization. They do not delve into the general query optimization considered here. Vassilakis presents an optimization scheme for sequences of coalescing and temporal selection; when introducing coalescing to our framework, this scheme can be adopted in the form of transformation rules. We use some techniques for estimating the selectivity of temporal predicates (when histograms are not available), and we also show how selectivity can be estimated by using solely statistics available from conventional DBMSs.

Several papers have considered cost estimation in heterogeneous systems. Du et al. propose a cost model with different cost formulas for different selection and join methods. Cost factors used in the formulas are deduced in a calibration phase, when a number of sample queries are run on the DBMS. We use a similar approach (recall Section 5.2), but we assume that we do not know the specific algorithms used by the DBMS. Adall et al. argue that predetermined cost models are sometimes unavailable and statistics may not be easily accessible (particularly from non-relational DBMSs); for this scenario, they suggest to estimate the cost of executing a query by using cached statistics of past queries. Because statistics are easily available in our setting, we do not exploit this type of technique.

TANGO is implemented using the Volcano extensible query optimizer and the XXL library of query processing algorithms. Volcano was significantly extended to include new operators, algorithms, and transformation rules, as well as different types of equivalences (Section 4). Available XXL algorithms for regular operators, as well as our own algorithms for temporal operators, were used in TANGO's Execution Engine.

7 Conclusions

This invention offers a temporal middleware approach to building temporal query language support on top of conventional DBMSs. Unlike previous approaches, this middleware performs some query optimization, thus dividing the query processing between itself and the DBMS, and then coordinates and takes part in the query evaluation. Performance experiments show that performing some query processing in the middleware in some cases improves query performance up to an order of magnitude over performing it all in the DBMS. This is because complex operations, such as temporal aggregation, which DBMSs have difficulty in processing efficiently, have efficient implementations in the middleware.

The invention's contributions are several. It proposes an architecture for a temporal middleware with query optimization and processing capabilities. The middleware query optimization and processing explicitly and consistently address duplicates and order. Heuristics, cost formulas, and selectivity estimation techniques for temporal operators (using available DBMS statistics) are provided. The temporal middleware architecture is validated by an implementation that extends the Volcano optimizer and the XXL query processing system. Performance experiments validate the utility of the shared processing of queries, as well as of the cost-based optimization.

The result is a middleware-based system, TANGO, which captures the functionality of previously proposed temporal stratum approaches, and which is more flexible.

The proposed transformation rules and selectivity estimation techniques may also be used in an integrated DBMS, e.g., when adding temporal functionality to object-relational DBMSs via user-defined functions. For this to work, the user-defined functions must manipulate relations and must be able to specify the cost functions and transformation rules relevant to them to the optimizer.

Several directions for future work exist. The current middleware algorithms should be enhanced to support very large relations. In addition, new operators may be added to TANGO. To add an operator, one needs to specify relevant transformation rules, formulas for derivation of statistics, and algorithm(s) implementing the operator. If the operator is to be implemented in the middleware, its algorithm has to be added to the Execution Engine.

DBMS query processing statistics, such as the running times of query parts, may be used to update the cost factors used in the middleware's cost formulas. It is an interesting challenge to be able to divide the running time between the TRANSFER^{M} algorithm and, possibly, several DBMS algorithms. A number of other refinements are also possible. For example, if a query is to access the same DBMS relation twice (even if the projected attributes are different), it would be beneficial to issue only one T^{M} operation.

1. A database-based application comprising means for processing temporal queries from a user capable of entering queries, said application comprising the following layers:
a user application layer for interaction between the user and said database-based application for entering queries,
a middleware layer overlying a Database Management System (DBMS) and said middleware layer being intended for processing temporal queries from the user,
the Database Management System (DBMS) layer for processing queries and for accessing data in a database,
said database-based application further comprising:
means for generating a number of query plans according to queries having been entered by the user by means of said user application layer,
each said query plan specifying combinations of operations to be performed and establishing whether the operation should be performed in the middleware layer or the DBMS layer,
means for estimating the cost in processing resources according to each said query plan,
means for selecting, according to a criteria, which query plan to be used when processing a query, said criteria being based on the result from said cost calculating means.

2. A database-based application according to claim 1, wherein said processing resources comprise IO resources and CPU resources.

3. A database-based application according to claims 1 or claim 2, wherein the means for estimating the cost comprises further means for estimating the selectivity of a temporal selection, said estimate of the selectivity being intended for using the information that an end time of a period never precedes a start time of the period.

4. A database-based application according to claim 3, wherein the estimation of selectivity further is intended for using information about temporal data to be selected from a set of data, said information intended for being placed in histograms based on a start time and an end time of the period.

5. A database-based application comprising means for processing temporal queries from a user entering a number of queries, said application comprising the following layers:
a user application layer for interaction between the user and said database-based application for entering queries,
a Database Management System (DBMS) layer for processing queries and for accessing data in a database,
said database-based application further comprising:
means for generating a number of query plans according to queries having been entered by the user by means of said user application layer
each said query plan capable of specifying combinations of operations to be performed,
means for estimating the cost in processing resources according to each said query plan by estimating the selectivity of a temporal selection, said estimate of the selectivity intended for being performed by using the information that an end time of a period never precedes a start time of the period.

6. A database-based application according to claim 5, wherein the estimation of selectivity furthermore is capable of using information about temporal data to be selected from a set of data, said information intended for being placed in histograms based on the start time and end time of the period.

7. A database-based application comprising means for processing temporal queries from a user capable of entering queries, said application comprising the following layers:
a user application layer for interaction between the user and said database based application for entering queries by the user,
a Database Management System (DBMS) layer for processing queries and accessing the data in a database,
said database-based application further comprising means for performing temporal aggregation, said means intended for performing temporal aggregation and comprising:
means for sorting grouping attributes and corresponding start time of a period in a first table, and means for sorting the grouping attributes and corresponding end time of the period in a second table, and
means for performing the temporal aggregation by using said first and second table.

8. A method of processing queries in a database-based application, said application comprising the layers
a user application layer being used for interaction between the user and said database based application for entering a number of queries by the user,
a middleware layer being used for processing temporal queries,
a Database Management System (DBMS) layer being used for processing queries and accessing the data in a database, said method performing the steps of:
generating a number of query plans according to queries entered by the user, each query plan specifying combinations of operations to be performed and establishing whether the operation should be performed in the middleware layer or in the DBMS layer,
estimating the cost in processing resources according to each query plan,
selecting, according to a criteria, which query plan to be used when processing a query, said criteria being based on the result from said step of calculating the cost.

9. A method according to claim 8, wherein estimating the cost in processing resources comprise estimating cost in IO resources and in CPU resources.

10. A method according to claim 8 or claim 9, wherein the step of estimating the cost comprises the step of estimating the selectivity of a temporal selection, said estimate of the selectivity using the information that an end time of a period never precedes a start time of the period.

11. A method according to claim 10, wherein the estimation of selectivity further uses information about temporal data to be selected from a set of data, said information being placed in histograms based on the start time and end time of the period.

12. A method of processing queries in a database-based application, said application comprising the following layers:
a user application layer being used for interaction between the user and said database based application for entering queries by the user,
a middleware layer overlying a Database Management System (DBMS) and said middleware layer being intended for processing temporal queries,
a Database Management System (DBMS) layer for processing queries and for accessing the data in a database,
said method performing the steps of:
generating a number of query plans according to queries entered by the user, each query plan specifying combinations of operations to be performed,
estimating the cost in processing resources according to each query plan by estimating the selectivity of a temporal selection, said estimate of the selectivity being performed using the information that an end time of a period never precedes a start time of the period.

13. A method according to claim 12, wherein the estimation of selectivity further uses information about temporal data to be selected from a set of data, said information being placed in histograms based on the start time and end time of the period.

14. A method of processing queries in a database based application, said application comprising the following layers:
a user application layer being used for interaction between the user and said database based application for entering queries by the user,
a middleware layer overlying a Database Management System (DBMS) and said middleware layer being intended for processing temporal queries,
the Database Management System (DBMS) layer for processing queries and for accessing the data in a database,
said method performing temporal aggregation, said performing of temporal aggregation comprising the steps of:
sorting the grouping attributes and a corresponding start time of a period in a first table, and sorting the grouping attributes and a corresponding end time of the period in a second table,
performing the temporal aggregation using said first and second table.
